(19) United States
(12) Patent Application Publication
(10) Pub. No.: US 2007/0230457 A1
(43) Pub. Date: Oct. 4, 2007

(54) Authentication VLAN management apparatus

(75) Inventors: Kimiaki Kodera, Kawasaki (JP); Junichi Yoshio, Kawasaki (JP); Akiyoshi Yoneyama, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/504,498

(22) Filed: Aug. 15, 2006

(30) Foreign Application Priority Data
Mar. 29, 2006 (JP) 2006-90700

(51) Int. Cl. H04L 12/56; H04J 3/02

(52) U.S. Cl. 370/389; 370/462

(57) ABSTRACT

An authentication VLAN management apparatus acquires from the standard LAN switch a MAC address or an IP address of a terminal connected to a standard LAN switch, and authenticates the terminal based on the acquired MAC address or IP address. Based on the above authentication result, the authentication VLAN management apparatus assigns a predetermined VLAN to the terminal, and sets the standard LAN switch so that the terminal can access to the assigned VLAN.

### CROSS-REFERENCE TO RELATED APPLICATIONS

This application is based upon and claims the benefit of priority from the prior Japanese Patent Application No. 2006-90700, filed on Mar. 29, 2006, the entire contents of which are incorporated herein by reference.

### BACKGROUND OF THE INVENTION

1. Field of the Invention

The present invention relates to an authentication VLAN, and more particularly an authentication VLAN management apparatus capable of providing an authentication VLAN function for a VLAN having no LAN switch dedicated for an authentication VLAN.

2. Description of the Related Art

A VLAN (Virtual Local Area Network) is a technology virtually dividing a single LAN into a plurality of groups. The VLAN is grouped on a port-by-port basis connected by a LAN cable, by which each group virtually constitutes a separate LAN. Accordingly, there is a restriction in the grouping depending on a physical connection position.

In contrast, according to the authentication VLAN, each VLAN to which a user belongs can be separated on a basis of a user ID and a password (namely, for each user). By this, the physical restriction of the connection position is removed, that is, any user can access the VLAN, which the user concerned belongs to, from any access location. In other words, it is possible to restrict a VLAN the user can access depending on the authority of the user. Meanwhile, the user being in connection to a certain VLAN cannot access another VLAN.

When a terminal is connected to a LAN, the terminal concerned is connected to a default VLAN which becomes an entry. The terminal is connected to a predetermined VLAN through authentication using a user ID and a password performed in an authentication server of the default VLAN. When the authentication fails, the control in regard to the terminal of interest is left in the default VLAN. Thus, an illegal access to a LAN is avoided. By introducing the authentication VLAN, access control on a personal basis can be realized, in which an access is restricted to resources necessary for a job. Thus, undesirable leakage of corporate information can be prevented.

FIG. 1 shows an exemplary configuration of the conventional authentication VLAN system. A dedicated LAN switch 12 is a LAN switch provided for dedicated use for an authentication VLAN having an authentication VLAN function, which includes an authentication function such as the function of IEEE 802.1X.

Here, the IEEE 802.1X is one of the LAN standards established by the IEEE (Institute of Electrical and Electronics Engineers) 802 Committee, in which a LAN becomes available after a terminal is authenticated in a LAN switch or a wireless LAN access point connecting the terminal, and the user is verified to be genuine. Dedicated LAN switch 12 conforming to IEEE 802.1X has a function of communicating with terminal 16 for authentication, and passing or blocking frames from terminal 16 according to the result of the above authentication.

In terminal 16, authentication client software called “supplicant” is required for receiving authentication. The function of the supplicant is to communicate information necessary for authentication according to a fixed procedure, and when the authentication is successful, the terminal concerned becomes able to use the LAN via the LAN switch.

The subject actually authenticating the user is an authentication server 14 in the default VLAN. The dedicated LAN switch 12 transfers authentication information (such as the user ID and the password) received from the supplicant to authentication server 14, and authentication server 14 decides whether or not the LAN is permitted to use. An authentication protocol between the dedicated LAN switch 12 and authentication server 14 is, for example, Extensible Authentication Protocol (EAP).

When authentication server 14 permits, terminal 16 is assigned to the permitted VLAN. Namely, the dedicated LAN switch 12 enables the above terminal 16 to access job server 200 corresponding to the permitted VLAN.

Additionally, in the official gazette of the Japanese Unexamined Patent Publication No. 2002-366522, there is disclosed an authentication VLAN system in which a device is authenticated using device information stored in a security token, and further a user is authenticated using use time information stored in the security token, so as to identify a VLAN connectable from the client.

Also, in the official gazette of the Japanese Unexamined Patent Publication No. 2005-196279, there is disclosed an authentication VLAN system in which, when a management terminal transmits to a management server a connection block request in regard to a predetermined terminal, a switching section blocks the connection of the predetermined terminal.

In the official gazette of the Japanese Unexamined Patent Publication No. 2005-197815, there is disclosed an authentication VLAN system in which a terminal can access either an ordinary LAN or a special network provided for a security measure, depending on a state of the security measure in the terminal.

Further, in the official gazette of the Japanese Unexamined Patent Publication No. 2005-203984, there is disclosed a VLAN system in which set information and operation information are presented safely to an individual user only for the information related to the user concerned, so that other users cannot look in any set content being set by a user nor an operation data in regard to the processing result.

However, when introducing an authentication VLAN system into a network constituted of standard LAN switches having no authentication function, it is necessary to replace a standard LAN switch by a LAN switch 12 dedicated for use for an authentication VLAN. As compared to the standard LAN switch, LAN switch 12 dedicated for use for the authentication VLAN is expensive, which brings an increase of the introduction cost, as well as a restriction on equipment options.

Further, because a VLAN being assigned to a terminal at the time of authentication cannot be changed during connection, in order to change the VLAN assigned to the terminal, it is necessary to disconnect the terminal once from the LAN switch. After changing the settings in the authentication server, procedures for reconnection and re-authentication are required, which impedes flexible VLAN operation.

### SUMMARY OF THE INVENTION

Accordingly, it is an object of the present invention to provide an authentication VLAN management apparatus capable of providing an authentication VLAN function to a VLAN having no LAN switch dedicated for use for an authentication VLAN.

It is another object of the present invention to provide an authentication VLAN management apparatus capable of dynamically assigning a terminal to an appropriate VLAN according to situation changes after the authentication.

As a first configuration of an authentication VLAN management apparatus according to the present invention to achieve the aforementioned object, the authentication VLAN management apparatus includes: an address acquisition unit acquiring a MAC address or an IP address of a terminal connected to a LAN switch from the LAN switch; an authentication unit authenticating the terminal based on the MAC address or the IP address acquired by the address acquisition unit; an assignment unit assigning a first VLAN to the terminal based on the authentication result by the authentication unit; and a set unit setting the LAN switch so as to enable the terminal to access the first VLAN.

As a second configuration of the authentication VLAN management apparatus according to the present invention, the authentication VLAN management apparatus includes: an address acquisition unit acquiring a MAC address or an IP address of a terminal connected to a LAN switch from the LAN switch; an authentication unit authenticating the terminal based on the MAC address or the IP address acquired by the address acquisition unit; an assignment unit assigning a first VLAN to the terminal based on the authentication result by the authentication unit and information related to the terminal; and a set unit setting the LAN switch so as to enable the terminal to access the first VLAN.

As a third configuration of the authentication VLAN management apparatus according to the present invention, in the above second configuration, the assignment unit changes the VLAN to be assigned to the terminal from the first VLAN to a second VLAN, based on the change of the information related to the terminal after the terminal became able to access the first VLAN, and the set unit sets the LAN switch so as to enable the terminal to access the second VLAN.

As a fourth configuration of the authentication VLAN management apparatus according to the present invention, in the above second configuration, the information related to the terminal is at least one set of information among the sets of information related to a VLAN use time of the terminal, information related to a result for participation to a lecture of a user using the terminal, information related to a network state, and information related to a connection schedule of the terminal.

As a fifth configuration of the authentication VLAN management apparatus according to the present invention, in the above fourth configuration, the assignment unit decides a terminal rank based on the information related to the VLAN use time of the terminal and the information related to a result for participation to a lecture of a user using the terminal, and assigns the first VLAN corresponding to the decided rank from among a plurality of VLANs.

As a sixth configuration of the authentication VLAN management apparatus according to the present invention, in the above fourth configuration, the assignment unit assigns the first VLAN having the best communication environment from among a plurality of VLANs, based on the information related to the network state.

As a seventh configuration of the authentication VLAN management apparatus according to the present invention, in the above fourth configuration, the assignment unit assigns the first VLAN having been registered in advance corresponding to the present time, based on the information related to the connection schedule of the terminal.

As an eighth configuration of the authentication VLAN management apparatus according to the present invention, in the above third configuration, the information related to the terminal is at least one set of information among the sets of information related to a VLAN use time of the terminal, information related to a result for participation to a lecture of a user using the terminal, information related to a network state, and information related to a connection schedule of the terminal.

As a ninth configuration of the authentication VLAN management apparatus according to the present invention, in the above eighth configuration, when either the information related to the VLAN use time of the terminal or the information related to a result for participation to a lecture of a user using the terminal is changed, the assignment unit changes the decided rank based on the change, so as to assign the second VLAN corresponding to the changed rank, in place of the first VLAN.

As a tenth configuration of the authentication VLAN management apparatus according to the present invention, in the above eighth configuration, when the information related to the network state is changed, based on the change, the assignment unit assigns the second VLAN having the best communication environment at the time of change, in place of the first VLAN.

As an eleventh configuration of the authentication VLAN management apparatus according to the present invention, in the above eighth configuration, the assignment unit changes from the first VLAN to the second VLAN at a predetermined time, based on a VLAN change time being set in the information related to the connection schedule of the terminal.

As a first computer program according to the present invention to achieve the aforementioned object, the computer program makes a computer apparatus execute the processing of: acquiring a MAC address or an IP address of a terminal connected to a LAN switch from the LAN switch; authenticating the terminal based on the MAC address or the IP address acquired by the address acquisition unit; assigning a first VLAN to the terminal based on the authentication result by the authentication unit; and setting the LAN switch so as to enable the terminal to access the first VLAN.

As a second computer program according to the present invention to achieve the aforementioned object, the computer program makes a computer apparatus execute the processing of: acquiring a MAC address or an IP address of a terminal connected to a LAN switch from the LAN switch; authenticating the terminal based on the MAC address or the IP address acquired by the address acquisition unit; assigning a first VLAN to the terminal based on the authentication result by the authentication unit and information related to the terminal; and setting the LAN switch so as to enable the terminal to access the first VLAN.

As a third computer program according to the present invention to achieve the aforementioned object, in the above second computer program, the computer program makes the computer apparatus execute the processing of: changing the VLAN to be assigned to the terminal from the first VLAN to a second VLAN, based on the change of the information related to the terminal after the terminal became able to access the first VLAN; and setting the LAN switch so as to enable the terminal to access the second VLAN.

By introducing the authentication VLAN management apparatus according to the present invention, by means of authentication using a MAC address or an IP address, an authentication VLAN function can be provided at low cost without providing a dedicated LAN switch for an existing network which is constituted of standard LAN switches having no authentication VLAN function.

Also, it is possible to dynamically change a VLAN once assigned to a terminal according to a variety of environment changes or state changes after the assignment, enabling an optimal VLAN assignment constantly.

Further scopes and features of the present invention will become more apparent by the following description of the embodiments with the accompanied drawings.

### BRIEF DESCRIPTION OF THE DRAWINGS

FIG. 1 shows a diagram illustrating a configuration example of the conventional authentication VLAN system.

FIG. 2 shows a diagram illustrating a configuration example of an authentication VLAN system according to an embodiment of the present invention.

FIG. 3 shows a diagram illustrating a block configuration example of an authentication VLAN management apparatus 100.

FIG. 4A shows an exemplary data structure of vendor information.

FIG. 4B shows an exemplary data structure of authentication information 106.

FIG. 4C shows an exemplary data structure of VLAN set information 108.

FIG. 4D shows an exemplary data structure of use time information 110.

FIG. 4E shows an exemplary data structure of schedule information 112.

FIG. 4F shows an exemplary data structure of network state information 114.

FIG. 4G shows an exemplary data structure of application information 119.

FIG. 5 shows an operation sequence of VLAN assignment decision processing in the authentication VLAN management apparatus according to an embodiment of the present invention.

FIG. 6 shows a diagram illustrating a first operation sequence of VLAN assignment change processing in the authentication VLAN management apparatus according to an embodiment of the present invention.

FIG. 7 shows a diagram illustrating a second operation sequence of VLAN assignment change processing in the authentication VLAN management apparatus according to an embodiment of the present invention.

FIG. 8 shows a diagram illustrating a third operation sequence of VLAN assignment change processing in the authentication VLAN management apparatus according to an embodiment of the present invention.

FIG. 9 shows a diagram illustrating a fourth operation sequence of VLAN assignment change processing in the authentication VLAN management apparatus according to an embodiment of the present invention.

FIG. 10 shows a diagram illustrating a fifth operation sequence of VLAN assignment change processing in the authentication VLAN management apparatus according to an embodiment of the present invention.

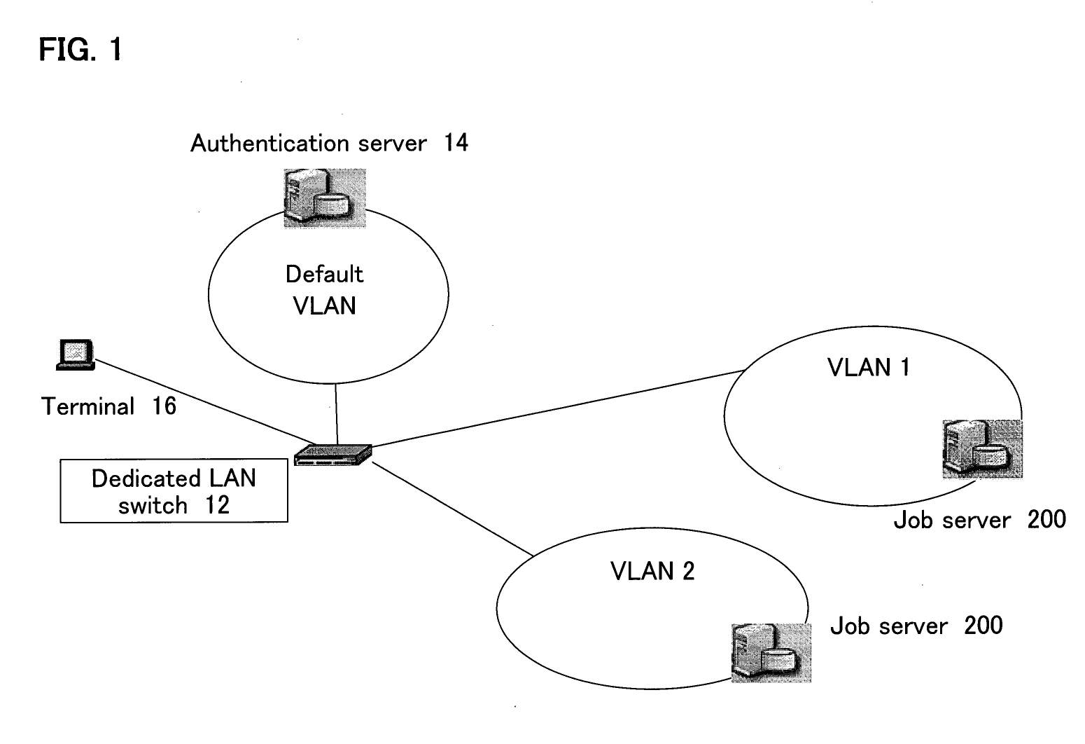

### DETAILED DESCRIPTION OF THE PREFERRED EMBODIMENTS

The preferred embodiment of the present invention is described hereinafter referring to the charts and drawings. However, it is noted that the technical scope of the present invention is not limited to the embodiments described below.

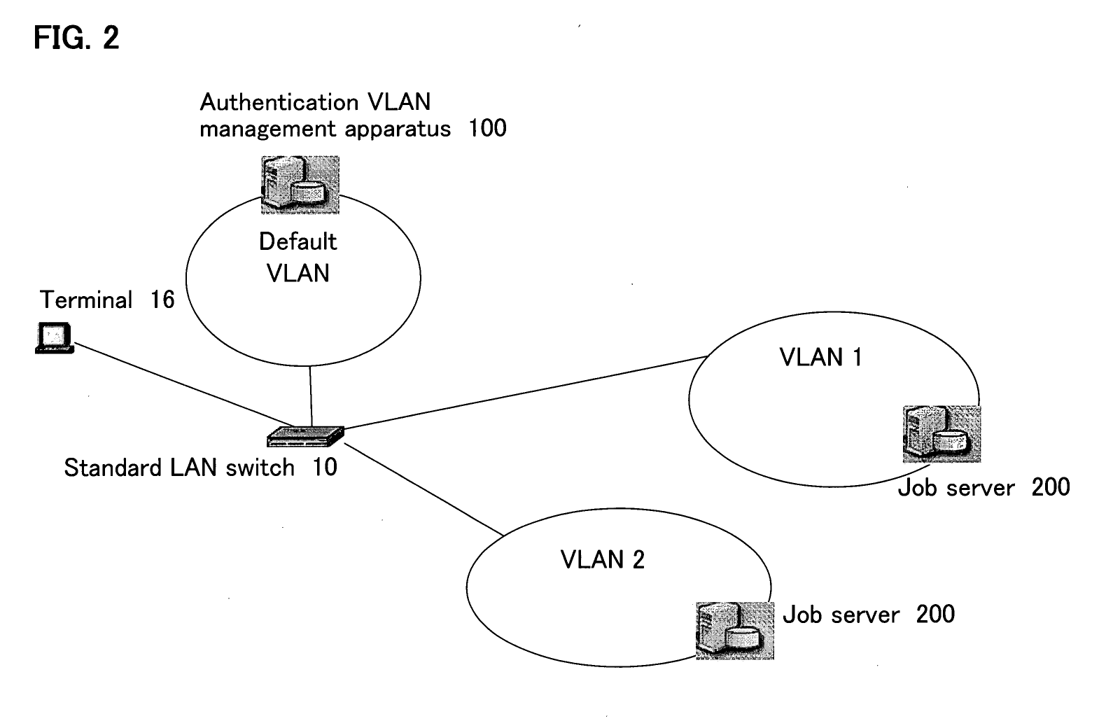

FIG. 2 shows a diagram illustrating a configuration example of an authentication VLAN system according to the embodiment of the present invention. A LAN switch 10 is a general LAN switch (hereafter referred to as a standard LAN switch) having no authentication function. In the above standard LAN switch 10, there are stored a MAC address learning table retaining the relationship between a port number connecting a terminal and a MAC address of the terminal concerned, and an ARP (Address Resolution Protocol) table retaining the relation of correspondence between the above MAC address and an IP address.

Authentication VLAN management apparatus 100 is an authentication server of a default LAN, and realizes functions featuring the present invention, as described later. Authentication VLAN management apparatus 100 authenticates terminal 16 being connected to standard LAN switch 10. As a result of the authentication, when terminal 16 is permitted to be assigned to a predetermined VLAN, standard LAN switch 10 is set so that terminal 16 is assigned to the predetermined VLAN. For example, when terminal 16 is assigned to VLAN 1, terminal 16 is permitted to access a job server 200-1 of VLAN 1, while when terminal 16 is assigned to VLAN 2, terminal 16 is permitted to access a job server 200-2 of VLAN 2.

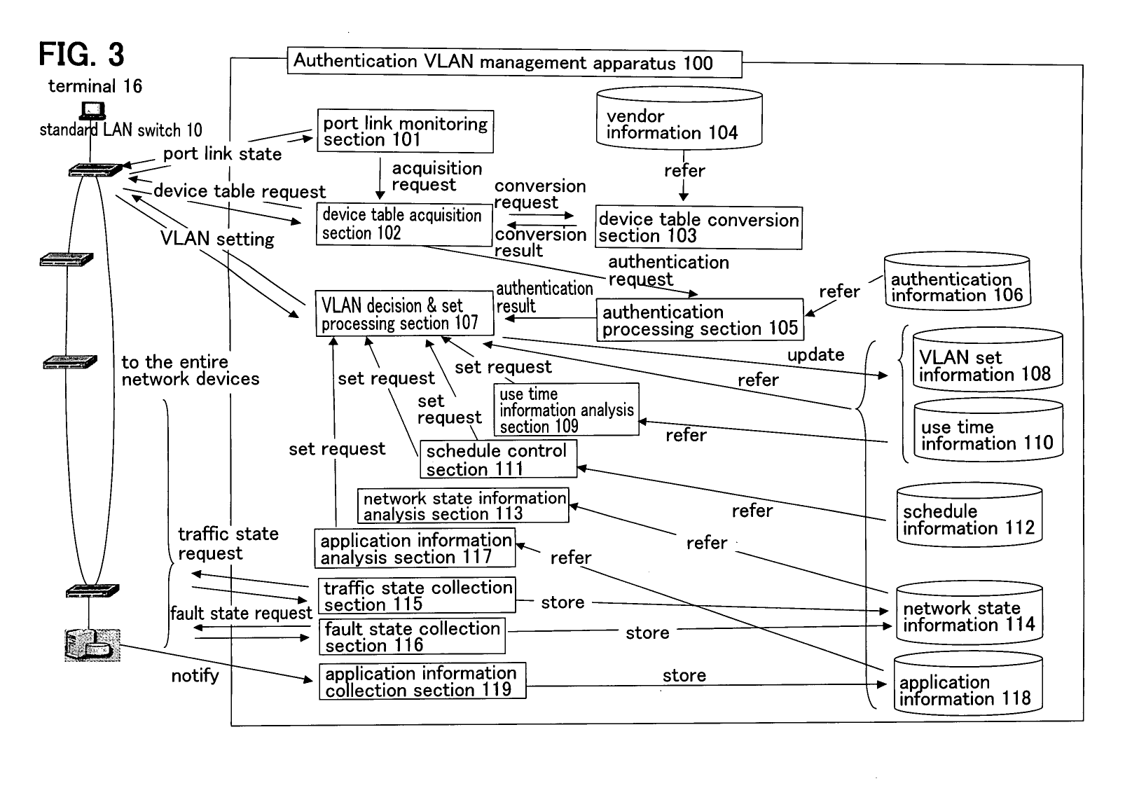

FIG. 3 shows a diagram illustrating a block configuration example of an authentication VLAN management apparatus 100. A port link monitoring section 101 monitors a port link state whether a terminal is connected to each port of standard LAN switch 10. A device table acquisition section 102 acquires the MAC address table and the ARP table stored in standard LAN switch 10. Standard LAN switch 10 acquires the MAC address of the terminal connected to the port, from a source MAC address of a packet being received from the terminal connected to the port, so as to store into the MAC address learning table in correspondence with the port number. Also, standard LAN switch 10 acquires a MAC address corresponding to the IP address of the terminal by unit of ARP broadcast, so as to store into the ARP table in correspondence with the IP address.

By acquiring the MAC address learning table and the ARP table, device table acquisition section 102 can acquire both the MAC address and the IP address of the terminal connected to the standard LAN switch 10.

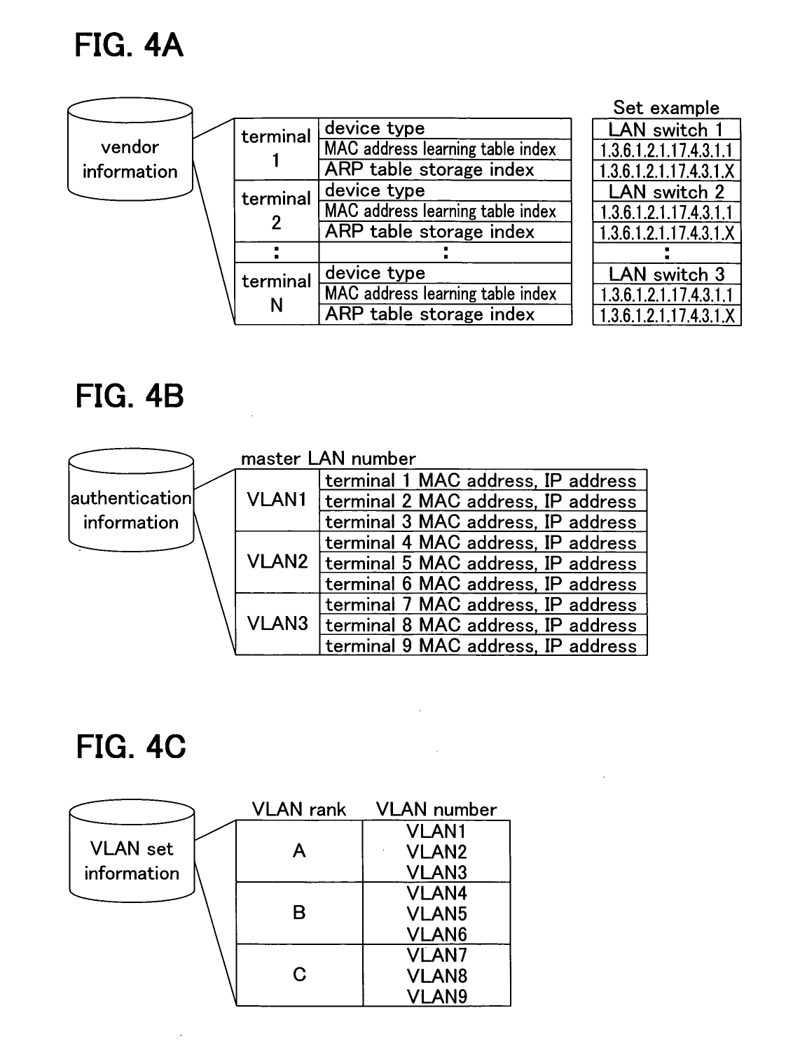

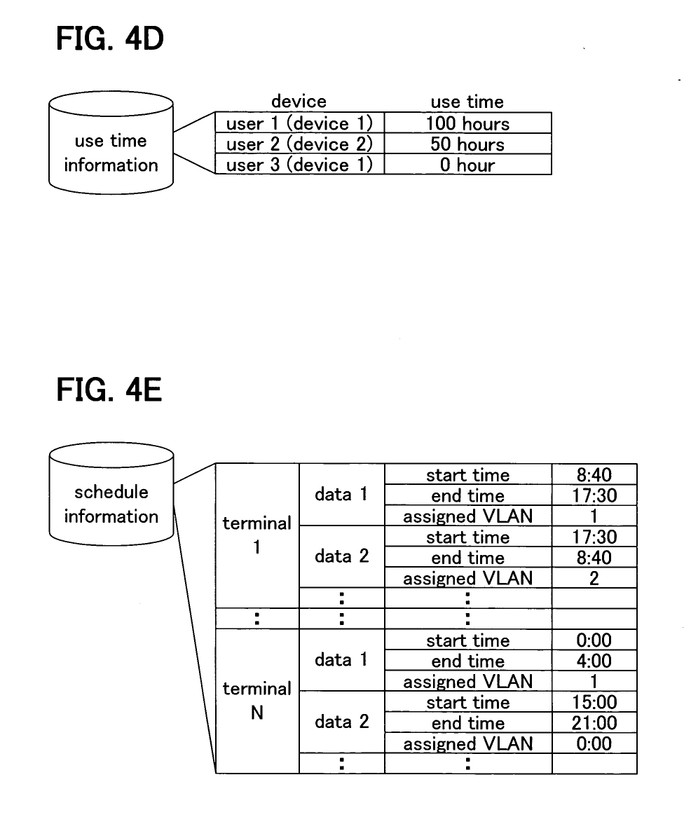

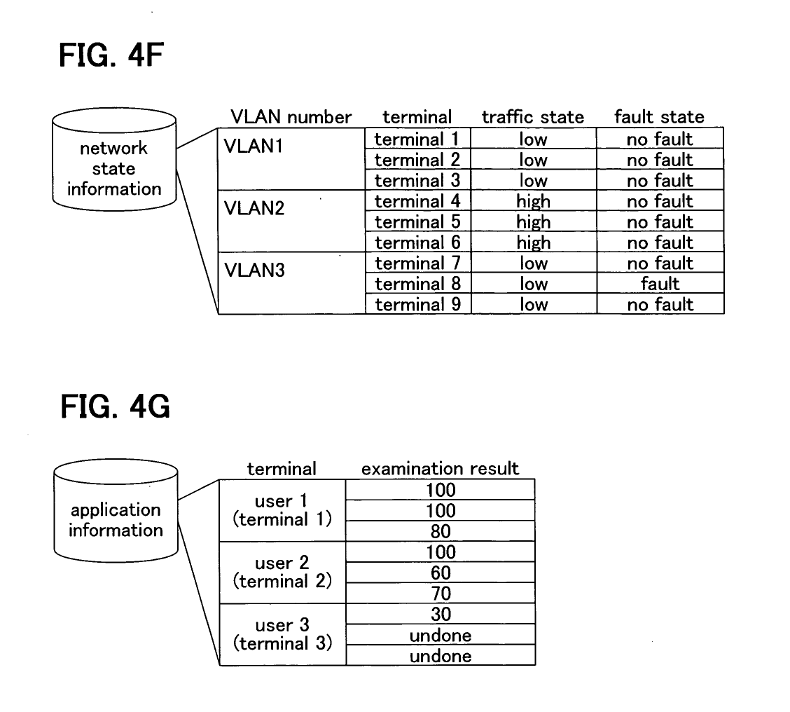

A device table conversion section 103 refers to vendor information 104, and absorbs the difference in the specifications of the MAC address learning table and the ARP table among standard LAN switches 10 of different types (in particular, vendors), so as to convert into common specification formats. FIG. 4A shows an exemplary data structure of vendor information. Vendor information 104 stores necessary information for analyzing the tables of which specifications are different vendor-by-vendor. Device table conversion section 103 converts the tables of different specifications into tables of unified specifications, based on the vendor information 104. The converted tables are forwarded to device table acquisition section 102, so as to be stored therein.

Authentication processing section 105 acquires the converted MAC address learning table and ARP table from device table acquisition section 102, and performs authentication of terminal 16 by referring to authentication information 106 using the MAC address or the IP address of terminal 16 as key. FIG. 4B shows an exemplary data structure of authentication information 106. The authentication information stores information corresponding to the MAC address or the IP address assigned to each of the plurality of VLANs. Authentication processing section 105 outputs, as an authentication result, a VLAN number corresponding to the MAC address or the IP address of terminal 16. When neither MAC address nor IP address of terminal 16 is registered as authentication information 106, information indicating no corresponding VLAN number is output as the authentication result.

A VLAN decision & set processing section 107 decides a VLAN to which terminal 16 is assigned, based on at least the authentication result from authentication processing section 105, and sets standard LAN switch 10 so that terminal 16 can access the decided VLAN. When the authentication result indicates that there is no corresponding VLAN number, terminal 16 remains to be connected to the default VLAN.

VLAN decision & set processing section 107 refers not only to the authentication result of authentication processing section 105, but also to VLAN set information, use time information, application information, network state information, etc., which will be described later, so as to decide the VLAN to which terminal 16 is to be assigned. VLAN decision & set processing section 107 then sets standard LAN switch 10 so that terminal 16 can access the decided VLAN.

Also, VLAN decision & set processing section 107 updates VLAN set information 108. FIG. 4C shows an exemplary data structure of VLAN set information 108. VLAN set information 108 stores a VLAN number which belongs to a current VLAN rank. Each VLAN is ranked based on a communication speed, an amount of accessible information, etc. The ranking is updated according to use time information, network state information, application information, etc., corresponding to the terminal assigned to each VLAN. When the ranks are divided into three categories, i.e. A (upper level), B (middle level) and C (lower level), information of each terminal stored in use time information, network state information and application information, which will be described later, is also ranked into three categories. Based on predetermined conditions, the combinations of the ranks of each set of information are classified into three categories of the VLAN ranks. Depending on the variation of the use time information, the network state information and the application information, the VLAN rank is also varied.

A use time information analysis section 109 analyzes use time information 110, and requests to set or change the VLAN to be assigned to the terminal. FIG. 4D shows an exemplary data structure of use time information 110. Use time information 110 stores a use time (an accumulated connection time with the assigned VLAN) on a terminal-by-terminal basis. As the use time becomes longer, the rank becomes higher. For example, to a terminal of which use time is longer than a predetermined time, use time information analysis section 109 requests assignment or change to a VLAN having a higher communication speed.

A schedule control section 111 requests setting or change of the VLAN assigned to each terminal according to schedule information 112. FIG. 4E shows an exemplary data structure of schedule information 112. In case that a VLAN assigned to a terminal is to be changed depending on time, schedule information 112 stores a set start time and a set completion time of VLAN assignment, and a VLAN number to be assigned to, on a terminal-by-terminal basis. When the VLAN number assigned from the authentication result is out of hours, the VLAN number corresponding to the schedule information is preferentially applied, according to the request from schedule control section 111.

A network state information analysis section 113 requests setting or change of a VLAN to be assigned to each terminal, by referring to network state information 114. FIG. 4F shows an exemplary data structure of network state information 114. Network state information 114 stores information such as a traffic situation and an existence or non-existence of a fault on a port connecting each terminal. Network state information analysis section 113 requests to assign a VLAN having a higher VLAN rank when the traffic is relatively high, as an example.

Traffic state collection section 115 collects data related to a traffic amount (such as number of transmission/reception packets, collision frequency, number of transmission/reception bytes, number of discarded packets, etc.), an access frequency, an accumulated connection time, etc. of each port in standard LAN switch 10, so as to store into network state information 114. A fault state collection section 116 collects fault state information such as a port fault or the occurrence or non-occurrence of a trouble on a terminal, so as to store into network state information 114.

An application information analysis section 117 analyzes application information 118, and requests to set or change the VLAN to be assigned to each terminal. FIG. 4G shows an exemplary data structure of application information 118. For example, application information 118 stores an examination result of a training lecture in which a terminal user participated. For example, when a user of a certain terminal participated in a lecture related to the network, and if the user obtains a relatively high mark in the examine result, application information analysis section 117 requests to assign a VLAN having a higher VLAN to the user terminal concerned.

An application information collection section 119 receives the examination result data from a predetermined job server managing the examination result data of the training lecture, so as to store into application information 118.

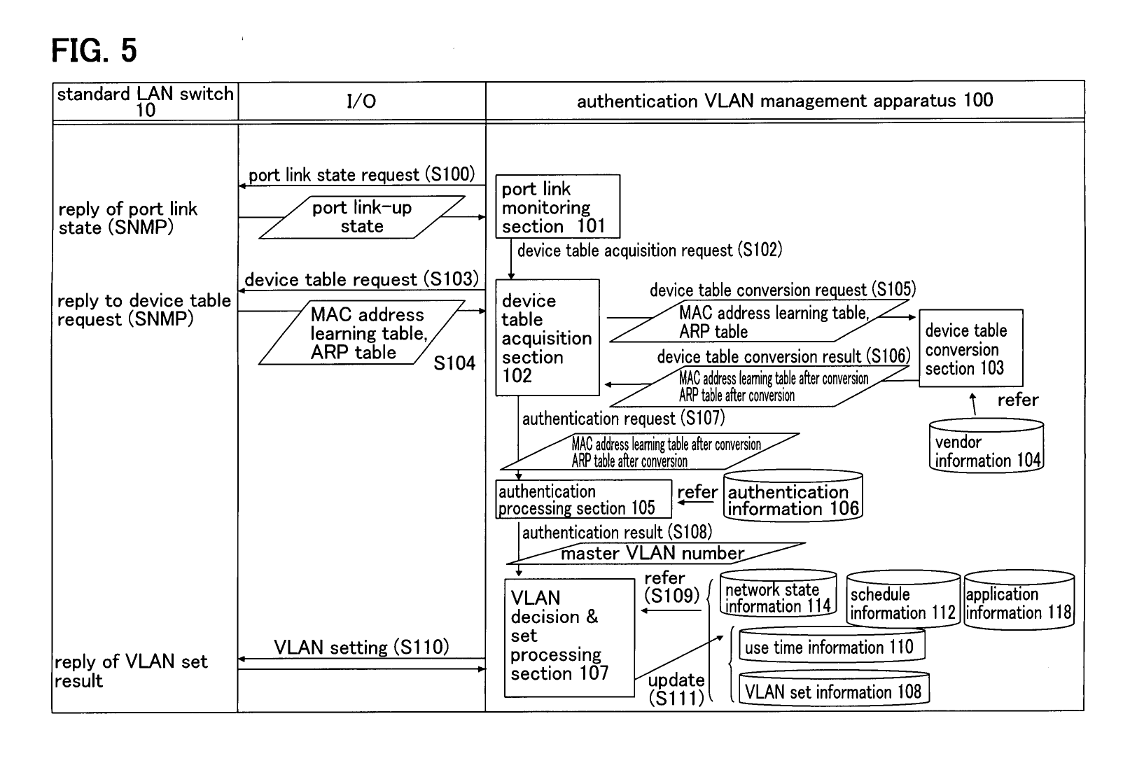

FIG. 5 shows an operation sequence of VLAN assignment decision processing in the authentication VLAN management apparatus according to an embodiment of the present invention. A port link monitoring section 101 transmits a port link state request to standard LAN switch 10 (S100), and in reply thereto, receives information of a port link-up state, i.e. connection state information of each port, from standard LAN switch 10 (S101).

When recognizing the connection of a new terminal from a port link-up state, port link monitoring section 101 requests device table acquisition section 102 to acquire a device table (MAC address learning table and ARP table) (S102). Device table acquisition section 102 then transmits a device table request to standard LAN switch 10 (S103) and on receiving a reply of the device table (S104), transmits the received table to device table conversion section 103, so as to request to convert the device table Device table conversion section 103 converts the MAC address learning table and the ARP table to each predetermined common format by referring to vendor information 104, and replies the converted MAC address learning table and the converted ARP table to device table acquisition section 102 (S106).

On acquiring the converted MAC address learning table and the converted ARP address, device table acquisition section 102 issues an authentication request to authentication processing section 105 (S107). Authentication processing section 105 then notifies VLAN decision & set processing section 107 of a VLAN number (master VLAN number) corresponding to each MAC address or each IP address, by referring to authentication information 106 (S108). The master VLAN number denotes a VLAN number which is assigned when authentication is made using only MAC address or IP address as key.

It is also possible for VLAN decision & set processing section 107 to decide the VLAN to be assigned by use of the notified master VLAN number.

As such, the authentication VLAN management apparatus acquires the MAC address or the IP address retained in standard LAN switch 10, and performs authentication of the terminal connected to standard LAN switch 10 based on the acquired MAC address or IP address. Thus, it becomes possible to configure an authentication VLAN even in case of a LAN constituted of standard LAN switches 10 having no authentication function. Accordingly, it is not necessary to purchase an expensive LAN switch for dedicated use. Thus, neither a cost increase is produced, nor device options are restricted.

VLAN decision & set processing section 107 refers to VLAN set information 108, use time information 110, schedule information 112, network state information 114 and application information 118, in addition to the master VLAN number obtained from authentication information 106 (S109). Then, VLAN decision & set processing section 107 decides an optimal VLAN to be assigned, and performs VLAN setting to standard LAN switch 10 so that each terminal can access the VLAN assigned (S110). Further, from the authentication processing result, VLAN decision & set processing section 107 can know the existence or non-existence of the port connection of the terminal. Therefore, by measuring the terminal connection time, i.e. the accumulated use time, VLAN decision & set processing section 107 updates use time information 110 at an appropriate time, and also updates VLAN set information 108 at an appropriate time, according to the changed VLAN rank (S111).

Now, a decision example of the VLAN to be assigned based on a variety of kinds of information will be described below. First, a VLAN rank is decided. The VLAN rank (information stored in VLAN set information 108) is decided by referring to use time information 110, application information 118 and network state information 114.

Use time information 110 stores use time on a basis of each user (terminal), which is ranked depending on use time categories.

Use time of 100 hours or more: Rank A

Use time of 50 hours or more, and less than 100 hours: Rank B

Use time less than 50 hours: Rank C

Application information 118 stores the examination result of a training lecture in which a user participated, which is also ranked depending on the examination result as shown below.

Examination result of average 80 marks or more: Rank A

Examination result of average 50 marks or more, and less than 80 marks: Rank B

Examination result less than average 50 marks: Rank C

The VLAN rank is decided depending on the combination of the rank of use time information 110 and the rank of application information 118, and the rank of network state information 114.

For example, (1) when the rank of use time information 110 is ‘A’, and the rank of application information 118 is ‘A’, the VLAN rank is decided as also ‘A’; (2) when the rank of use time information 110 is ‘A’, and the rank of application information 118 is ‘B’, the VLAN rank is decided as ‘B’, etc. The VLAN rank of each terminal is decided by VLAN decision & set processing section 107.

When the VLAN rank is decided, a VLAN number corresponding to the decided VLAN rank is extracted by referring to VLAN set information 108. For example, when the VLAN rank is ‘A’, a plurality of VLAN numbers, VLAN1, VLAN2 and VLAN3 are extracted.

After the plurality of VLAN ranks are extracted, by referring to the network state information, a VLAN having relatively low traffic and having no fault occurrence is selected from among the extracted VLAN numbers.

More specifically, each VLAN is ranked depending on a traffic amount or the existence or non-existence of a fault. For example, network state information 114 stores the traffic amount and the existence or non-existence of the fault on a basis of each VLAN, and the ranks are set depending on the traffic amount and the fault existence as follows.

Traffic amount of less than a predetermined value, and no fault existent: Rank A

Traffic amount of a predetermined value or larger, and no fault existent: Rank B

Existence of a fault: Rank C

When a plurality of VLAN numbers are extracted, VLAN decision & set processing section 107 acquires a network rank of each VLAN corresponding to each VLAN number from network state information analysis section 113, and selects the VLAN having the highest rank (the rank A is the highest, descending to B, C). When the selected VLAN number is different from the master VLAN number, the VLAN number selected based on the variety of kinds of information is decided as the VLAN to be assigned.

The above description is merely an example, and for example, it may also be possible to decide the VLAN number specified by schedule information 112 as the VLAN to be assigned. In the above case, when the master VLAN number according to authentication information 106 differs from the VLAN number at the present time being specified by schedule information 112, the VLAN number in schedule information 112 is preferentially applied.

As such, authentication is performed by use of the MAC address or the IP address of a terminal, and an optimal VLAN can be decided according to a continuously varying present state and condition of the terminal, based on a variety of kinds of information in regard to the terminal (namely, VLAN set information 108, use time information 110, schedule information 112, network state information 114 and application information 118), instead of assigning the VLAN fixedly to the MAC address or the IP address.

Also, by setting from the authentication VLAN management apparatus to the standard LAN switch, it becomes unnecessary to provide an expensive dedicated LAN switch having a VLAN authentication function. Thus, an authentication VLAN system can be introduced into an existing network at low cost.

Further, the difference in the MAC address learning table and the ARP table among the different vendors of the standard LAN switch and equipment is absorbed using vendor information 104. Thus, restrictions which may be brought by different vendors and equipment types can be avoided.

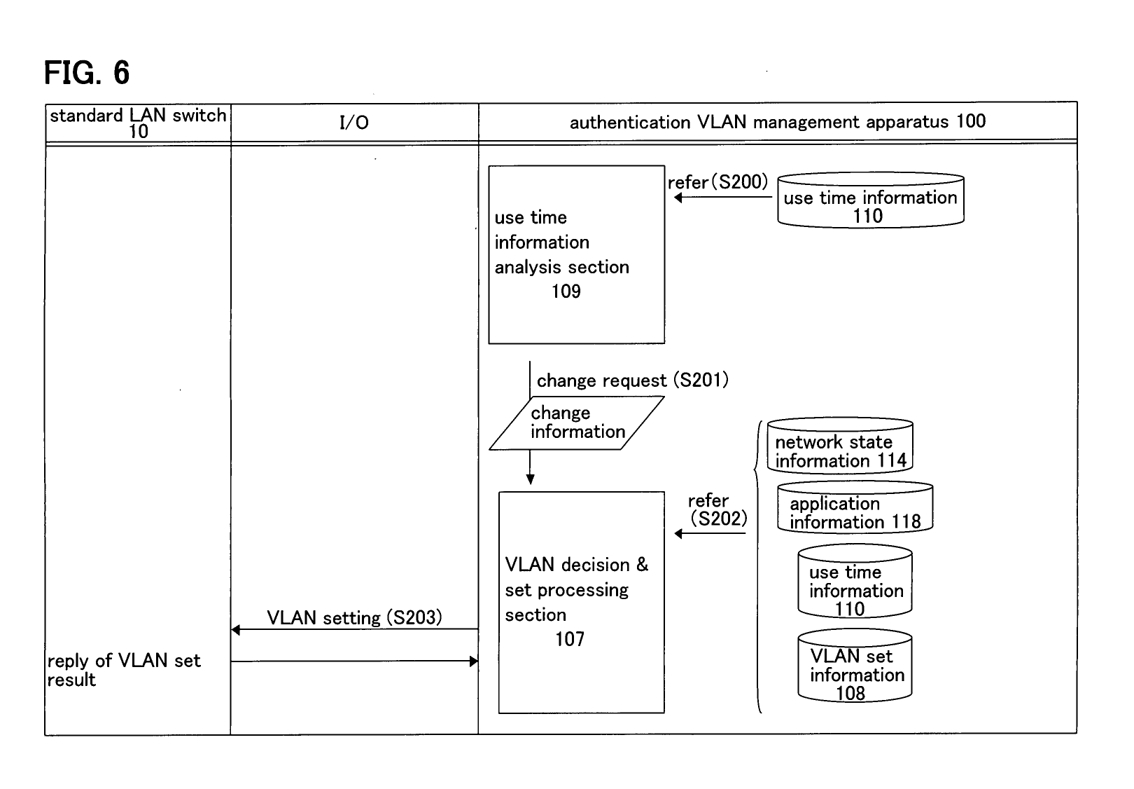

FIG. 6 shows a diagram illustrating a first operation sequence of VLAN assignment change processing in the authentication VLAN management apparatus according to the embodiment of the present invention. In the case that terminal 16 is authenticated by the VLAN assignment decision processing shown in FIG. 5, and that an optimal VLAN at that point of time is assigned, it is possible to change the VLAN assignment according to a situation change thereafter. FIG. 6 shows an example of changing the VLAN assignment initiated by a change request from use time information analysis section 109.

Use time information analysis section 109 refers to use time information 110 (S200), and requests VLAN decision & set processing section 107 to change the assignment when the past actual result (accumulated use time, traffic amount and access count) of terminal 16 reaches a certain level (S201). For example, when the accumulated use time in terminal 16 of a user A reaches 100 hours, the rank of use time information is changed from the rank B to the rank A. By this, use time information analysis section 109 transmits to VLAN decision & set processing section 107 change information to the effect that the rank of the use time information of terminal 16 corresponding to the user A has been changed, so as to request for change.

Based on the request for change, VLAN decision & set processing section 107 refers to use time information 110 and application information 118, as described in the above-mentioned example shown in FIG. 5 (S202), and decides again the VLAN rank (the information stored in VLAN set information 108), and then extracts the VLAN number corresponding to the decided VLAN rank. Then, taking into consideration a network rank based on network state information 114, VLAN decision & set processing section 107 decides one VLAN number. Since the assigned VLAN number is also changed when the VLAN rank has been changed, the VLAN setting is made to standard LAN switch 10 so that terminal 16 can access the changed VLAN (S203).

As such, by changing the assigned VLAN after reviewing the VLAN having been assigned in the initial authentication processing depending on the change of a terminal connection condition and an actual result, such as the change of the use time, it becomes possible to assign a more suitable VLAN in relation to the terminal connection condition and the actual result.

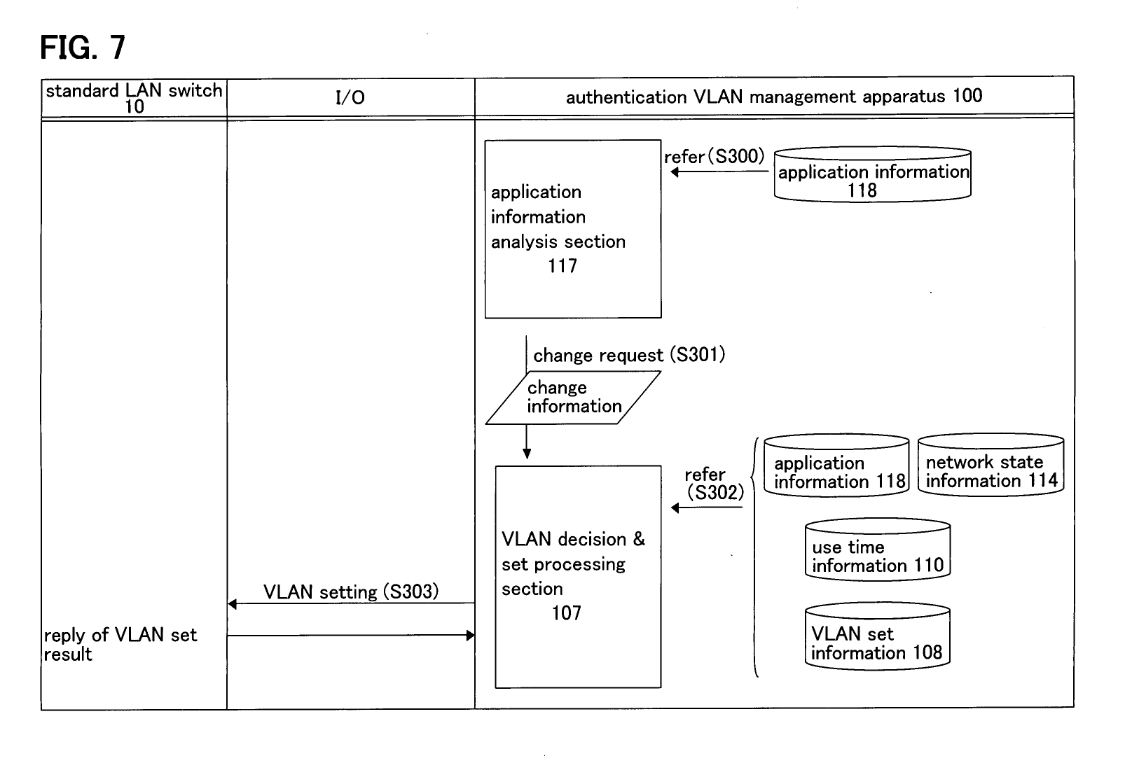

FIG. 7 shows a diagram illustrating a second operation sequence of VLAN assignment change processing in the authentication VLAN management apparatus according to the embodiment of the present invention. In FIG. 7, there is shown an example of changing the VLAN assignment initiated by a request for change from application information analysis section 117.

Application information analysis section 117 refers to application information 118 (S300), and requests VLAN decision & set processing section 107 to change the assignment when the user record of terminal 16 (a participating state of predetermined training and an examination result) reaches a predetermined level (S301). For example, when the average examination result of the user A of terminal 16 has been degraded from 80 marks to less than 80, the application information rank is changed from the rank A to the rank B. By this, application information analysis section 117 transmits to VLAN decision & set processing section 107 change information to the effect that the application information rank of terminal 16 corresponding to the user A has been changed, so as to request for change.

Based on the request for change, VLAN decision & set processing section 107 refers to use time information 110 and application information 118, as described in the above-mentioned example shown in FIG. 5 (S302), and decides again the VLAN rank (the information stored in VLAN set information 108), and then extracts the VLAN number corresponding to the decided VLAN rank. When a plurality of VLAN ranks are extracted, taking into consideration a network rank based on network state information 114, VLAN decision & set processing section 107 decides one VLAN number having the highest network rank. Since the assigned VLAN number is also changed when the VLAN rank has been changed, the VLAN setting is made to standard LAN switch 10 so that terminal 16 can access the changed VLAN (S303).

As such, by changing the assigned VLAN after reviewing the VLAN having been assigned in the initial authentication processing, depending on the change of a user condition and an actual result such as the examination result of the user using the terminal, it becomes possible to assign a more suitable VLAN in relation to the user condition and the actual result.

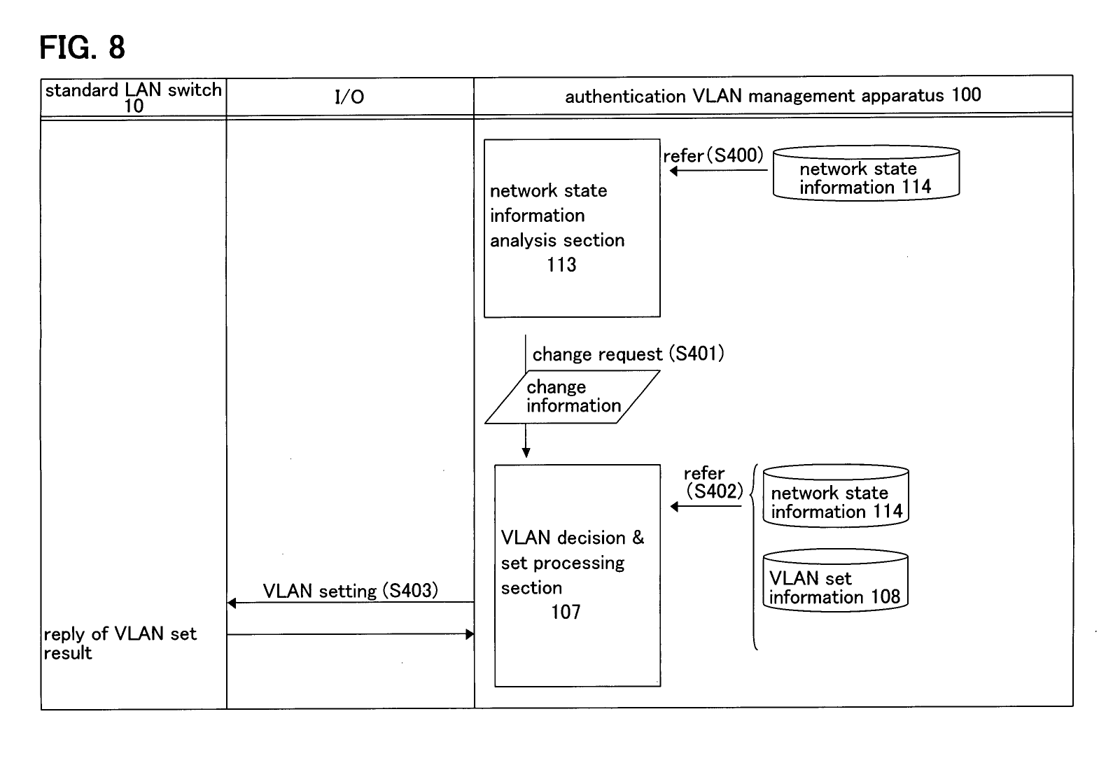

FIG. 8 shows a diagram illustrating a third operation sequence of VLAN assignment change processing in the authentication VLAN management apparatus according to the embodiment of the present invention. In FIG. 8, there is shown an example of changing the VLAN assignment initiated by a request for change from network state information analysis section 113.

Network state information analysis section 113 refers to network state information 114 (S400), and, on detecting a change in the VLAN network state assigned to terminal 16, requests VLAN decision & set processing section 107 to change the assignment (S401). For example, when a fault occurs in the VLAN assigned to terminal 16, the network rank is degraded from the rank A or B to the rank C. By this, network state information analysis section 113 transmits to VLAN decision & set processing section 107 change information to the effect that the network rank of the VLAN assigned to terminal 16 has been changed, so as to request for change.

Based on the request for change, VLAN decision & set processing section 107 refers to use time information 110 and application information 118, as described in the above-mentioned example shown in FIG. 5 (S402), and decides again the VLAN rank (the information stored in VLAN set information 108), and then extracts the VLAN number corresponding to the decided VLAN rank. Taking into consideration the network rank again based on network state information 114 among the extracted plurality of VLAN numbers, VLAN decision & set processing section 107 decides one VLAN number having the highest network rank. Since the network rank of the VLAN currently assigned has been changed, the VLAN number assigned also changes. Then, the VLAN setting is made to standard LAN switch 10 so that terminal 16 can access the changed VLAN (S403).

As such, by changing the assigned VLAN after reviewing the VLAN having been assigned in the initial authentication processing depending on the changes of the network state such as the traffic condition and the existence or non-existence of a fault, it becomes possible to assign a more suitable VLAN. Even when a particular VLAN becomes unavailable due to either access concentration to a service provided by a particular VLAN or a fault in a terminal or a line, it is possible to change the assignment to a replaceable VLAN, and thus, a stable communication environment can be provided.

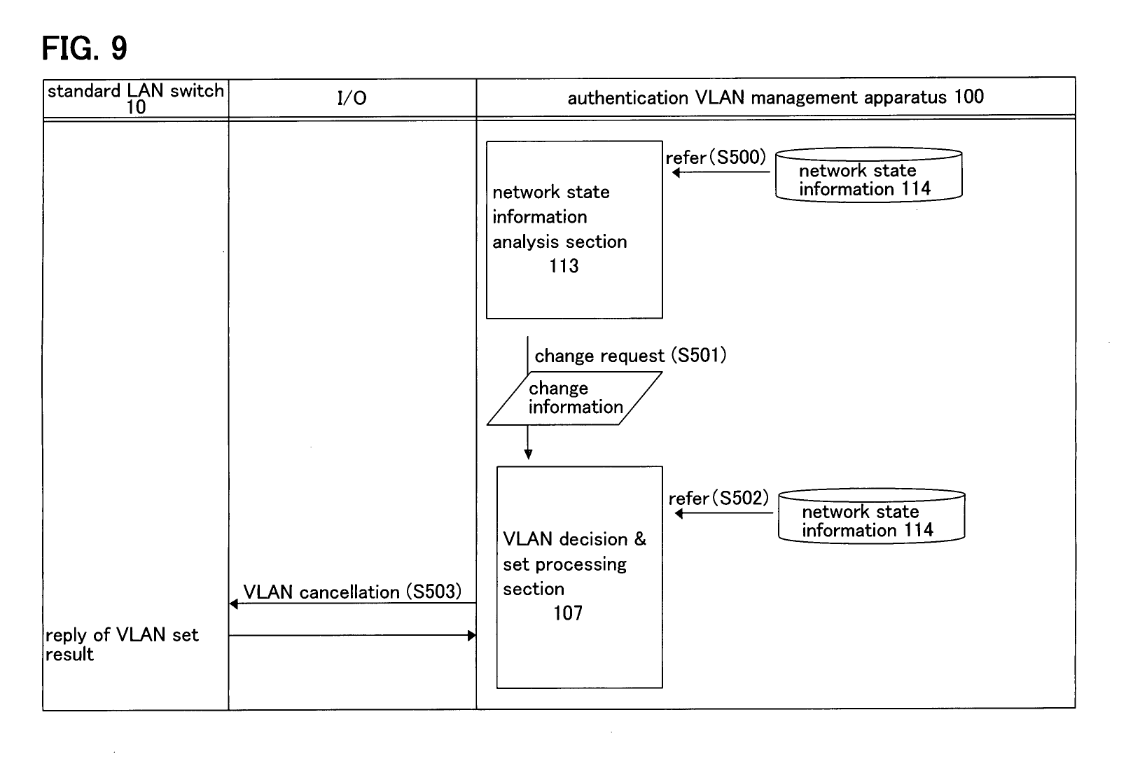

FIG. 9 shows a diagram illustrating a fourth operation sequence of VLAN assignment change processing in the authentication VLAN management apparatus according to the embodiment of the present invention. In FIG. 9, there is shown an example of restoring from the VLAN assigned to a terminal to the default VLAN, initiated by a request for change from network state information analysis section 113.

Network state information analysis section 113 refers to network state information 114 (S500), and analyzes the traffic amount of the port in standard LAN switch 10 connecting terminal 16. On detecting a state that there is no access to the VLAN (the number of transmission/reception packets is zero) for a certain time, network state information analysis section 113 requests VLAN decision & set processing section 107 to change the assignment (change to the default VLAN) (S501).

On receiving the request for change to the default VLAN, VLAN decision & set processing section 107 performs VLAN setting to standard LAN switch 10 so as to restore from the VLAN currently assigned to terminal 16 to the default VLAN, without deciding the VLAN rank again (S503).

As such, in case that there is no access for a certain time, network connection in a physical level is disabled by disconnecting the connection with the VLAN having been assigned in the initial authentication processing. This enables prevention of an illegal access, and accordingly, the security is improved.

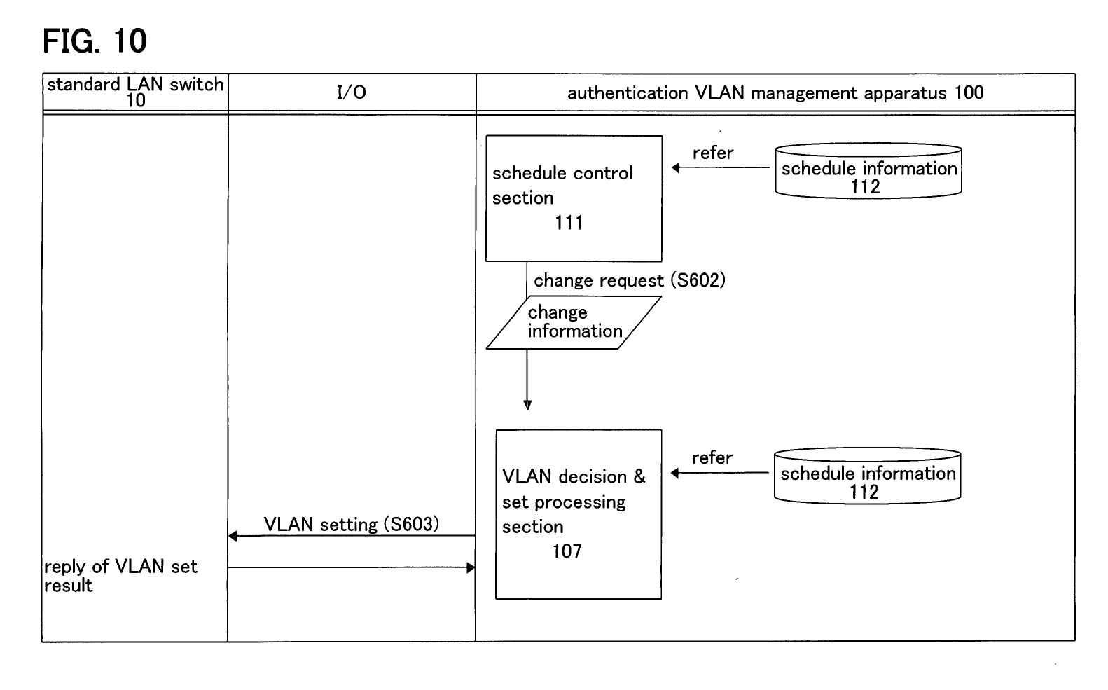

FIG. 10 shows a diagram illustrating a fifth operation sequence of VLAN assignment change processing in the authentication VLAN management apparatus according to the embodiment of the present invention. In FIG. 10, there is shown an example of changing the VLAN assignment initiated by a request for change from schedule control section 111.

Schedule control section 111 refers to schedule information 112 (S600), and, on detecting a VLAN assignment change schedule in regard to terminal 16, requests VLAN decision & set processing section 107 to change the assignment (S601). For example, when different VLANs are assigned to terminal 16 for a first time zone and a second time zone, respectively, at the start times of the first time zone and the second time zone, schedule control section 111 requests VLAN decision & set processing section 107 to change the assignment.

Based on the request for change from schedule control section 111, VLAN decision & set processing section 107 refers to schedule information 112 (S602), acquires a VLAN number assigned for the time zone corresponding to the present time, and decides the above VLAN as a VLAN to be assigned. Then, the VLAN setting is made to standard LAN switch 10 so that terminal 16 can access the decided VLAN (S603).

As such, by changing the VLAN having been assigned in the initial authentication processing to a VLAN to be assigned according to a time zone, it becomes possible to assign a more suitable VLAN. For a user in which the VLANs are separately provided on a job-by-job basis, and a job change occurs on a basis of each time zone, it is possible to automatically change the VLAN according to the job change.

The foregoing description of the embodiments is not intended to limit the invention to the particular details of the examples illustrated. Any suitable change and equivalents may be resorted to the scope of the invention. All features and advantages of the invention which fall within the scope of the invention are covered by the appended claims.

What is claimed is:

1. An authentication VLAN management apparatus comprising:
an address acquisition unit acquiring a MAC address or an IP address of a terminal connected to a LAN switch from the LAN switch;
an authentication unit authenticating the terminal based on the MAC address or the IP address acquired by the address acquisition unit;
an assignment unit assigning a first VLAN to the terminal based on the authentication result by the authentication unit; and
a set unit setting the LAN switch so as to enable the terminal to access the first VLAN.

2. An authentication VLAN management apparatus comprising:
an address acquisition unit acquiring a MAC address or an IP address of a terminal connected to a LAN switch from the LAN switch;
an authentication unit authenticating the terminal based on the MAC address or the IP address acquired by the address acquisition unit;
an assignment unit assigning a first VLAN to the terminal based on the authentication result by the authentication unit and information related to the terminal; and
a set unit setting the LAN switch so as to enable the terminal to access the first VLAN.

3. The authentication VLAN management apparatus according to claim 2,
wherein the assignment unit changes the VLAN to be assigned to the terminal from the first VLAN to a second VLAN, based on the change of the information related to the terminal after the terminal became able to access the first VLAN, and
wherein the set unit sets the LAN switch so as to enable the terminal to access the second VLAN.

4. The authentication VLAN management apparatus according to claim 2,
wherein the information related to the terminal is at least one set of information among the sets of information related to a VLAN use time of the terminal, information related to a result for participation to a lecture of a user using the terminal, information related to a network state, and information related to a connection schedule of the terminal.

5. The authentication VLAN management apparatus according to claim 4,
wherein the assignment unit decides a terminal rank based on the information related to the VLAN use time of the terminal and the information related to a result for participation to a lecture of a user using the terminal, and assigns the first VLAN corresponding to the decided rank from among a plurality of VLANs.

6. The authentication VLAN management apparatus according to claim 4,
wherein, based on the information related to the network state, the assignment unit assigns the first VLAN having the best communication environment from among a plurality of VLANs.

7. The authentication VLAN management apparatus according to claim 4,
wherein, based on the information related to the connection schedule of the terminal, the assignment unit assigns the first VLAN having been registered in advance corresponding to the present time.

8. The authentication VLAN management apparatus according to claim 3,
wherein the information related to the terminal is at least one set of information among the sets of information related to a VLAN use time of the terminal, information related to a result for participation to a lecture of a user using the terminal participated, information related to a network state, and information related to a connection schedule of the terminal.

9. The authentication VLAN management apparatus according to claim 8,
wherein, when either the information related to the VLAN use time of the terminal or the information related to a result for participation to a lecture of a user using the terminal is changed, the assignment unit changes the decided rank based on the change, so as to assign the second VLAN corresponding to the changed rank, in place of the first VLAN.

10. The authentication VLAN management apparatus according to claim 8,
wherein, when the information related to the network state is changed, based on the change, the assignment unit assigns the second VLAN having the best communication environment at the time of change, in place of the first VLAN.

11. The authentication VLAN management apparatus according to claim 8,
wherein, at a predetermined time, the assignment unit changes from the first VLAN to the second VLAN, based on a VLAN change time being set in the information related to the connection schedule of the terminal.

12. A computer program making a computer apparatus execute the processing of:
acquiring a MAC address or an IP address of a terminal connected to a LAN switch from the LAN switch;
authenticating the terminal based on the MAC address or the IP address acquired by the address acquisition unit;
assigning a first VLAN to the terminal based on the authentication result by the authentication unit; and
setting the LAN switch so as to enable the terminal to access the first VLAN.

13. A computer program making a computer apparatus execute the processing of:
acquiring a MAC address or an IP address of a terminal connected to a LAN switch from the LAN switch;
authenticating the terminal based on the MAC address or the IP address acquired by the address acquisition unit;
assigning a first VLAN to the terminal based on the authentication result by the authentication unit and information related to the terminal; and
setting the LAN switch so as to enable the terminal to access the first VLAN.

14. The computer program according to claim 13, further making the computer apparatus execute the processing of:
changing the VLAN to be assigned to the terminal from the first VLAN to a second VLAN, based on the change of the information related to the terminal after the terminal became able to access the first VLAN; and
setting the LAN switch so as to enable the terminal to access the second VLAN.
